(19) United States
(12) Patent Application Publication
(10) Pub. No.: US 2015/0022440 A1
(43) Pub. Date: Jan. 22, 2015

(54) DISPLAY AND METHOD OF DISPLAYING THREE-DIMENSIONAL IMAGES WITH DIFFERENT PARALLAXES

(71) Applicant: AU OPTRONICS CORPORATION, HSIN-CHU (TW)

(72) Inventors: Wei-Chan LIU, HSIN-CHU (TW); Hsin-Ying WU, HSIN-CHU (TW)

(73) Assignee: AU OPTRONICS CORPORATION, HSIN-CHU (TW)

(21) Appl. No.: 14/242,112

(22) Filed: Apr. 1, 2014

(30) Foreign Application Priority Data
Jul. 18, 2013 (TW) 102125760

(51) Int. Cl. G06F 3/01; H04N 13/04; G02B 27/22

(52) U.S. Cl. CPC G06F 3/013; G02B 27/2214; H04N 13/0484
USPC 345/156

(57) ABSTRACT

A display includes multiple pixels, a detecting device and an optical unit. Each of the pixels is configured to display a first image. The detecting device is configured to detect a position of a viewer to generate a position data. The optical unit cooperates with each of the pixels to project the first image to multiple viewable zones, in which an unobserved zone is formed between consecutive two of the viewable zones. Each of the pixels is configured to switch from a first image to a second image while the position data corresponds to the viewer located in the unobserved zone.

### RELATED APPLICATIONS

This application claims priority to Taiwan Application Serial Number 102125760, filed Jul. 18, 2013, which is herein incorporated by reference.

### BACKGROUND

1. Technical Field

The present disclosure relates to a display. More particularly, the present disclosure relates to a display with a detecting device.

2. Description of Related Art

Common auto-stereoscopic display techniques use lens or mask to project the light of pixel to different positions (or different view) in front of a display, and at the same time, an image of the pixel is controlled so as to make left and right eyes of a viewer see the image with parallax, which makes the viewer see the image as a stereoscopic image. However, limited by the optical system in the display, viewing range/viewing angle in which the viewer can see the stereoscopic image is limited. The viewer sees wrong image while he/she is out of the viewing range.

Recently, auto-stereoscopic display is usually equipped with an eye tracking system in order to increase the viewing range of the auto-stereoscopic display. Accordingly to the information provided by the eye tracking system, the auto-stereoscopic display timely performs operations to the signals which should be projected by each pixel in real time. However, the real-time operation for each pixel requires high precision. While the eyeball track system fails, or while position of the display is moved, it is easy to cause the viewer to see the wrong image.

Moreover, integral imaging display technique is the well-known candidate for achieving true 3D vision experience. However, the viewing zone wherein no transition of stereoscopic image occurs is intrinsically small as well. An eye-tracking system is adopted to eliminate the limitation but synchronization of pixel signal according to the real-time position is still a heavy task for the hardware system.

As a result, there is a need for solving the problems which still remain in the state of the art.

### SUMMARY

According to an aspect of the present disclosure, a display configured to provide images to a viewer is provided. The display includes multiple pixels, a detecting device and an optical unit. Each of the pixels is configured to display a first image. The detecting device is configured to detect a position of the viewer and to generate position data according to the position of the viewer. Each of the pixels is configured to cooperate with the optical unit to project the first image to multiple viewable zones, in which an unobserved zone is formed between consecutive two of the viewable zones. Each of the pixels is configured to switch from displaying a first image to displaying a second image while the position data corresponds to the viewer located in the unobserved zone.

According to another aspect of the present disclosure, a method for displaying multiple 3-dimension images with different parallaxes is provided. The method includes the following steps: displaying a first image by multiple pixels, cooperating each of the pixels with an optical unit to project the first image to multiple viewable zones, and forming an unobserved zone between consecutive two of the viewable zones; detecting a position of a viewer to generate position data according to the position of the viewer; and selectively switching image according to the position data, in which the step of selectively switching the image signals displayed by the pixels includes: switching the image displayed by one of the pixel from the first image to the second image while the position data corresponds to the viewer located in the unobserved zone of the one of the pixels.

According to another aspect of the present disclosure, a display is provided. The display includes: means for displaying a first image by a plurality of pixels, cooperating each of the pixels with an optical unit to project the first image to a plurality of viewable zones, and forming an unobserved zone between consecutive two of the viewable zones; means for detecting a position of a viewer to generate position data according to the position of the viewer; and means for selectively switching image according to the position data, wherein means for selectively switching the image displayed by the pixels comprises mean for switching the image displayed by one of the pixels from the first image to the second image while the position data corresponds to the viewer located in the unobserved zone of the one of the pixels.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a schematic diagram of a display according to an embodiment of the present disclosure;

FIG. 2 is a schematic diagram of pixels projecting image according to an embodiment of the present disclosure;

FIG. 3 is a detailed schematic diagram of the pixels in FIG. 2 projecting image to the central zone through lenses;

FIG. 4A-FIG. 4E are schematic diagrams of images from different vision angles according to an embodiment of the present disclosure;

FIG. 5 is a detailed schematic diagram of the pixels in FIG. 2 projecting the image to the left zone;

FIG. 6A-FIG. 6E are schematic diagrams images from different vision angles according to another embodiment of the present disclosure;

FIG. 7 is a detailed schematic diagram of pixels projecting images to a left zone according to another embodiment of the present disclosure;

FIG. 8 is a schematic diagram of a single pixel projecting a image according to an embodiment of the present disclosure;

FIG. 9 is a schematic diagram of relative positions of the viewer and the pixel in FIG. 8 according to an embodiment of the present disclosure;

FIG. 10 is a schematic diagram of relative positions of the viewer and the pixel in FIG. 8 according to another embodiment of the present disclosure;

FIG. 11 is a schematic diagram of relative positions of the viewer and the pixel in FIG. 8 according to a further embodiment of the present disclosure;

FIG. 12 is a schematic diagram of relative positions of a viewer and a pixel according to another embodiment of the present disclosure; and

FIG. 13 is an operation flow diagram according to an embodiment of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising”, or “includes” and/or “including” or “has” and/or “having” while used in this specification, specify the presence of stated features, zones, integers, steps, operations, elements, and/or components, but do not preclude the presence or addition of one or more other features, zones, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

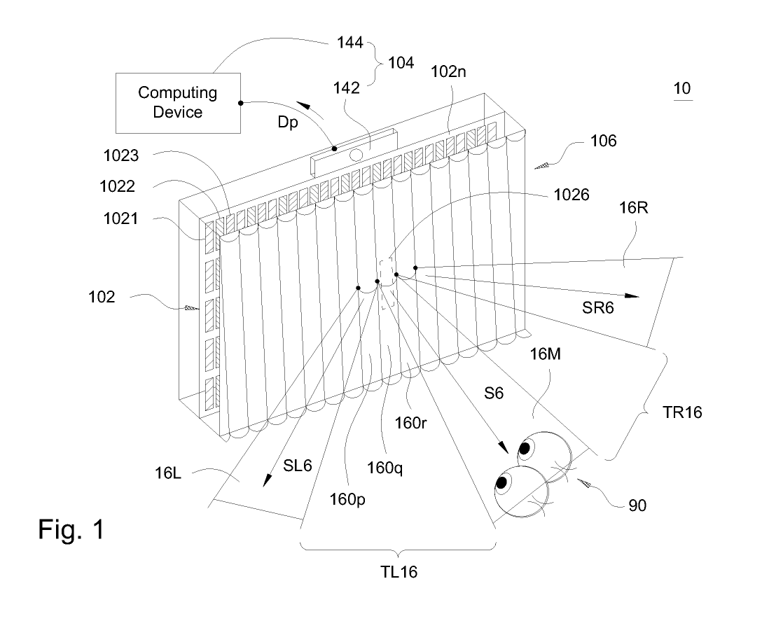

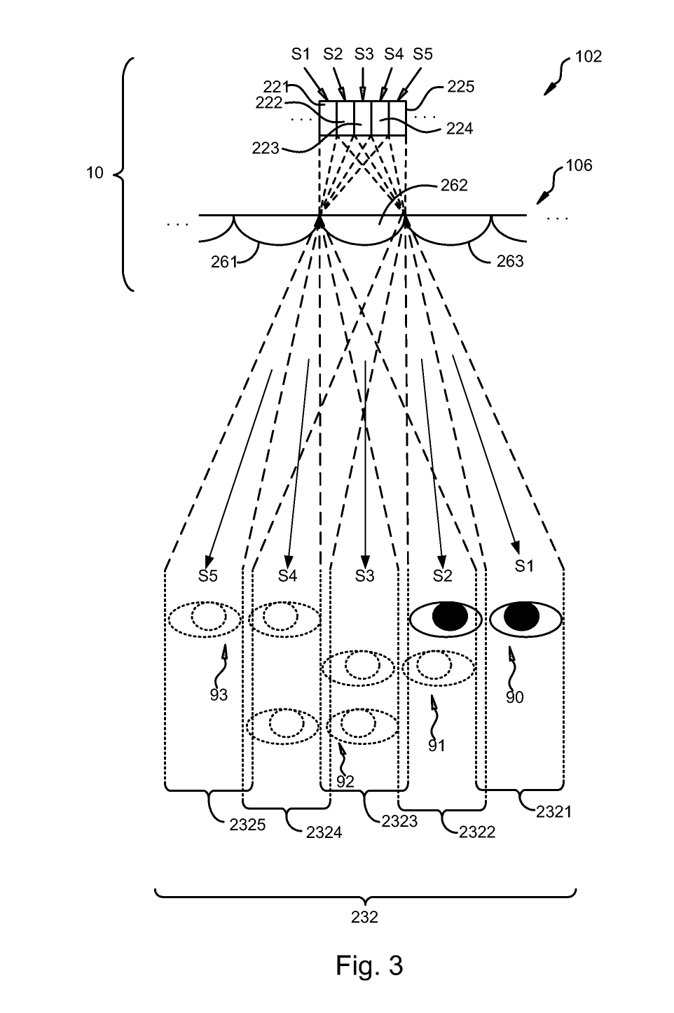

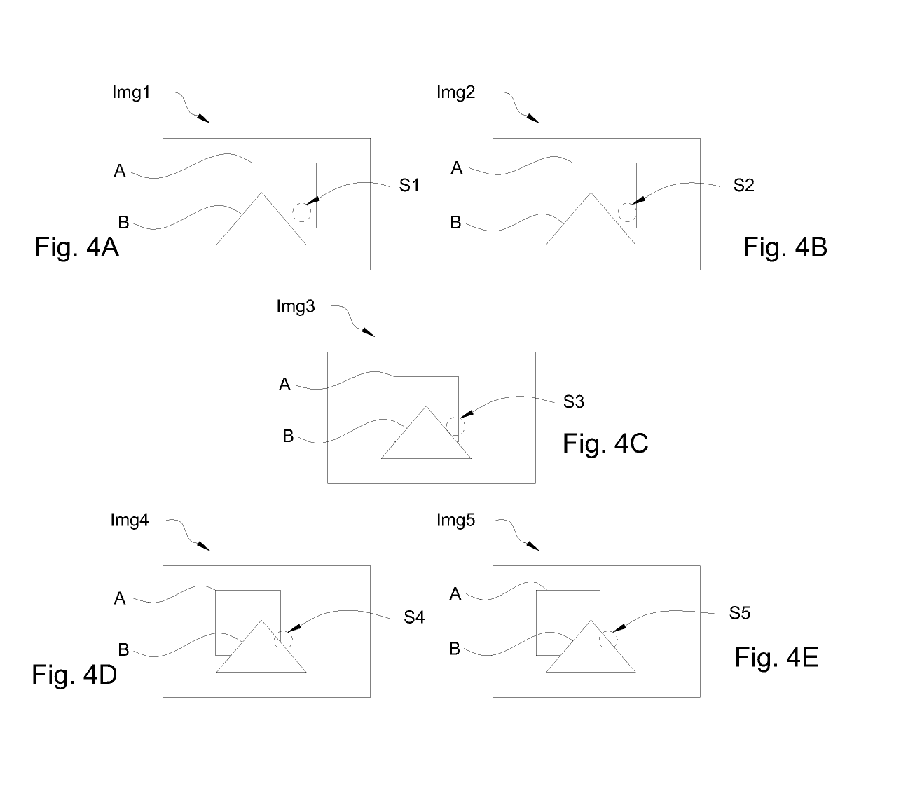

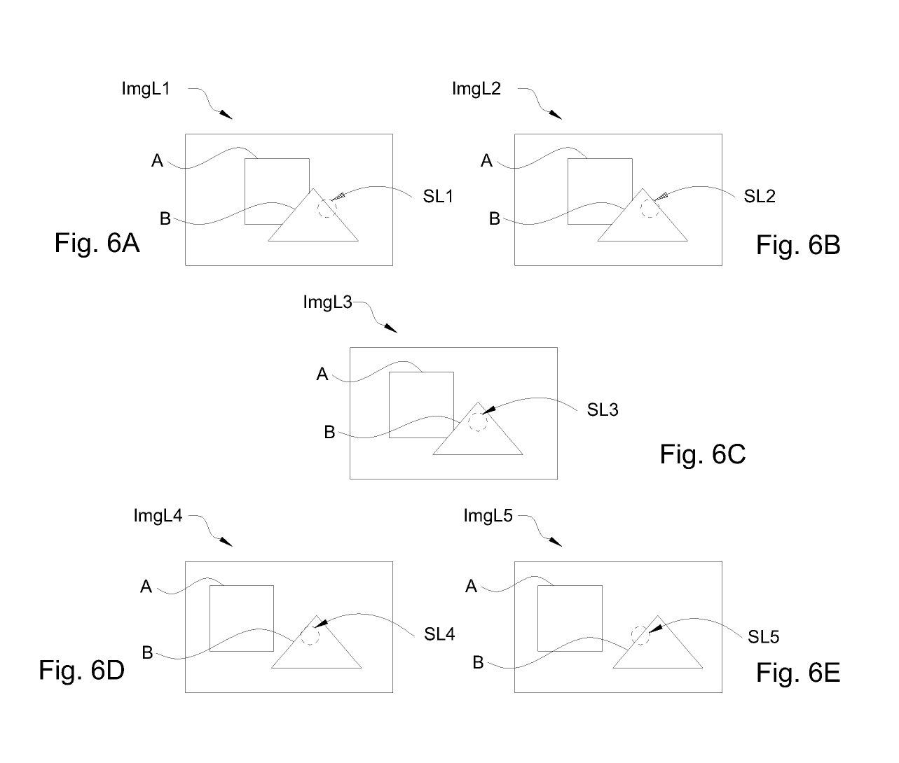

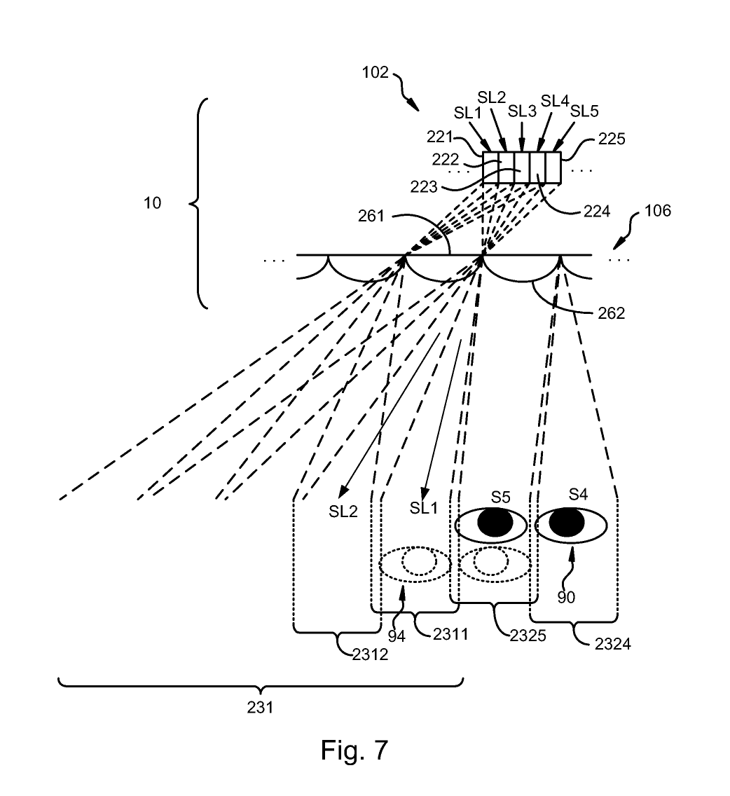

FIG. 1 is a schematic diagram of a display according to an embodiment of the present disclosure. A display 10 includes a detecting device 104, multiple pixels 1021, 1022 . . . and 102n and optical unit 106. The pixels 1021-102n are configured to display multiple images corresponding to multiple 3-dimensional images (illustrated in embodiments shown in FIGS. 4A-4E and FIGS. 6A-6E) with different parallaxes (illustrated in embodiments in FIG. 3 and FIG. 7). The optical unit 106 is configured to cooperate with each pixel 1021-1102n so as to display one of the images and to project to multiple viewable zones. For example, the optical unit 106 includes lenses 160p, 160q and 160r. The pixel 1026 projects an image SL6 to a viewable zone 16L through lens 106p. The pixel 1026 projects an image S6 to a viewable zone 16M through lens 106q. The pixel 1026 projects an image SR6 to a viewable zone 16R through lens 106r. An unobserved zone is formed between two neighboring viewable zones. For example, an unobserved zone TL16 is formed between the viewable zone 16L and viewable zone 16M, and an unobserved zone TR16 is formed between the viewable zone 16L and viewable zone 16M. The viewer 90 cannot observe images projected from pixel, or cannot observe correct image projected from pixel located at unobserved.

The detecting device 104 is configured to detect a position of a viewer 90, and to generate position data Dp according to the position of the viewer 90 (e.g., a position coordinate of eyes of the viewer 90 relative to the display 10). The pixels 1021-102n are further configured to switch signals according to the position data Dp so as to project corresponding images. For example, the pixel 1026 projects image SL6, image S6 and image SR6 with different vision angles to viewable zone 16L, viewable zone 16M and viewable zone 16R respectively.

While the position data Dp corresponds to the viewer 90 located in the unobserved zone TL16 between the viewable zone 16L and the viewable zone 16M or located in the unobserved zone TR16 between the viewable zone 16M and the viewable zone 16R, viewer 90 can not see the images of the pixel 1026. In the meanwhile, the pixel 1026 can switch to the image of a next vision angle so as to ensure that the viewer 90 can see a correct image of the next vision angle while the viewer 90 moves to the next vision angle. For example, while the position data Dp shows that the viewer 90 is located in the unobserved zone TL16, and while the viewer 90 gradually moves away from the viewable zone 16M and gradually moves to the viewable zone 16L, the pixel 1026 can switch to the image SL6 corresponding the vision angle.

On the other hand, while viewer is located in the unobserved zones of the pixel 1026, another image may be projected through neighboring pixels (or subpixels) of the pixel 1026 according to the position data Dp (detailed illustration are shown in the following paragraphs).

It is noted that each pixel 1021-102n may be a gray-level pixel, a red pixel, a blue pixel, a green pixel or a grouping pixel including at least one red subpixel, at least one blue subpixel and at least one green subpixel. In other words, the each pixel 1021-102n is not restricted to a pixel with a single color. Person of ordinary skills in the art can also take use of multiple subpixels with multiple colors to form each single pixel of the pixels 1021-102n.

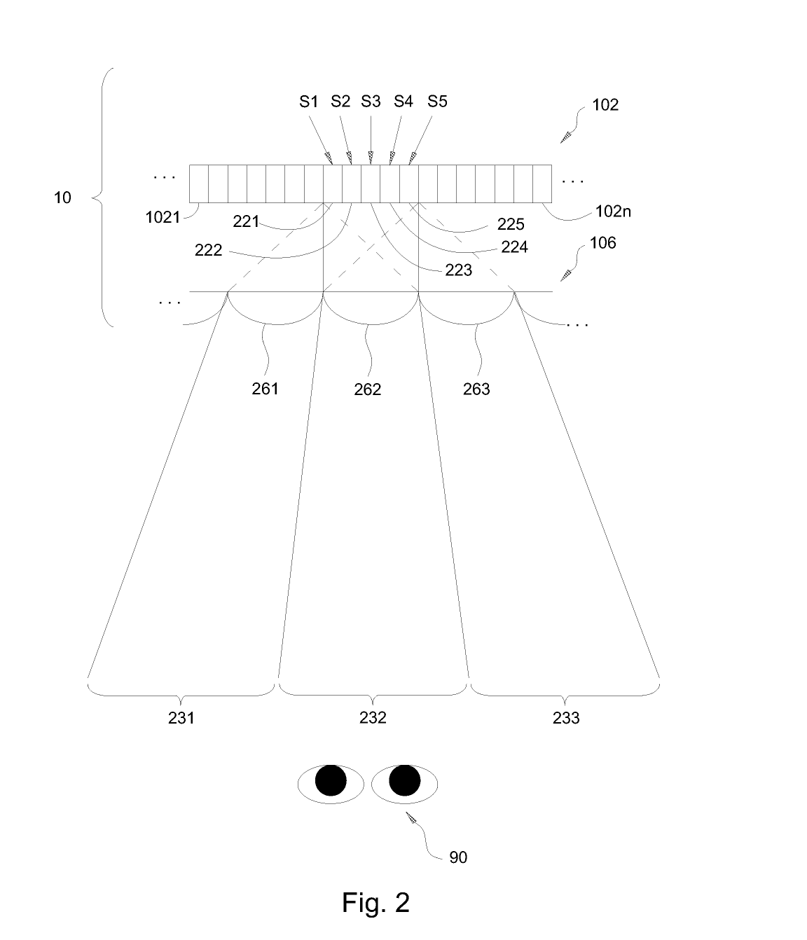

Configuration between the pixels 1021-102n and the optical unit 106 is illustrated in the FIG. 2 as an example. FIG. 2 is a schematic diagram of pixels projecting image according to an embodiment of the present disclosure. The pixels 1021-102n can be divided into multiple groups. Each of the groups includes N pixels, in which N is an integer. N pixels of the same group use the same lens to project images to the central viewable zone and use same lens to project images to the left and the right zones.

As shown in FIG. 2, the optical unit 106 includes lenses 261, 262 and 263. Multiple pixels 1021-102n are integrated on a panel 102. Every five of the pixels 1021-102n constitute a group, in which pixels 221-225 are grouped into the same group. The lens 262 is disposed directly opposite to the pixels 221-225 of the same group such that the pixels 221-225 can project images S1-S5 respectively displayed by the pixels 221-225 to a central zone 232. Moreover, the pixels 221-225 can respectively project the images S1-S5 to a left zone 231 through the lens 261 which is on the left of the lens 262. Similarly, the pixels 221-225 can respectively project the images S1-S5 to a right zone 233 through the lens 263 which is on the right of the lens 262.

Moreover, the pixels 221-225 can respectively define the left zone 231 and the right zone 233 through the lens 261 and 263. The pixels 221-225 can further defines multiple image projection zones on the left of the left zone 231 and multiple projection zones on the right of the right zone 233 through other lenses. It should not be construed as restricted to the present example. In addition, the optical unit 106 is not restricted to the lens structure, and the optical unit 106 can be constituted by the barrier structure.

The operation of pixels 221-225 projecting the images S1-S5 to the central zone 232 through the lens 262 is illustrated as below. An example is made to FIG. 3, and FIG. 3 is a detailed schematic diagram of the pixels in FIG. 2 projecting image to the central zone 232 through lens. As shown in FIG. 3, the pixels 221-225 respectively project images S1-S5 to different viewable zones 2321-2325 according to different angles, in which the angles are so called vision angles. The viewable zones 2321-2325 can be stacked as the central zone 232 such that the viewer 90 can see the images S1-S5 from different vision angles at different positions in the central zone 232.

For example, while the viewer 90 is inclined right in the central zone 232 as shown in FIG. 3, the right eye of the viewer 90 can see the image S1 in the viewable zone 2321, and the left eye of the viewer 90 can see the image S2 in the viewable zone 2322, in which the azimuth angles (or so called the viewing angles) of the projection from the images S1-S5 to the eyes of the viewer 90 are different. While the viewer 90 moves to a position 91, the right eye of the viewer 90 can see image S2 in the viewable zone 2322, and the left eye of the viewer 90 can see the image S3 in the viewable zone 2323. Similarly, while the viewer 90 moves to a position 92 or a position 93, the viewer can see different images based on the same manner, thus no repetitious details for those parts is given herein.

As shown in FIG. 4A-FIG. 4E, FIG. 4A-FIG. 4E are schematic diagrams of images from different vision angles according to an embodiment of the present disclosure. Images Img1-Img5 are two-dimensional images corresponding to different vision angles. Image objects A and B are shown in the image Img1-Img5, and relative relations, e.g., the relative distance, between the Image objects A and B, are different corresponding to the different vision angles. The images S1-S5 corresponds to the images Img1-Img5 with different vision angles. For example, images S1-S5 respectively corresponds to images blocks in a certain area, certain image pixels or the whole image of the images Img1-Img5.

Therefore, example is made to FIG. 3, while the images in FIG. 4 is applied in FIG. 3, the right eye of the viewer 90 can see the image S1 corresponding to the image Img1 in the circumstance that the viewer 90 is inclined right in the central zone 232. In the meanwhile, the left eye of the viewer 90 can see the image S2 corresponding to the image Img2 such that the viewer 90 can see the 3-dimensional image with a parallax. While the viewer 90 moves to the position 91, the right eye of the viewer 90 can see the image S2 corresponding to the image Img2, and the left eye of the viewer 90 can see the image S3 corresponding to the image Img3 at the same time such that the viewer can see a 3-dimensional image having a different parallax. Variations of the relative relation between the image objects A and B in images Img1-Img5 make the viewer 90 see the 3-dimensional image with motion parallax. In other words, the pixels 221-225 display images S1-S5 corresponding to the 3-dimensional images having different parallax.

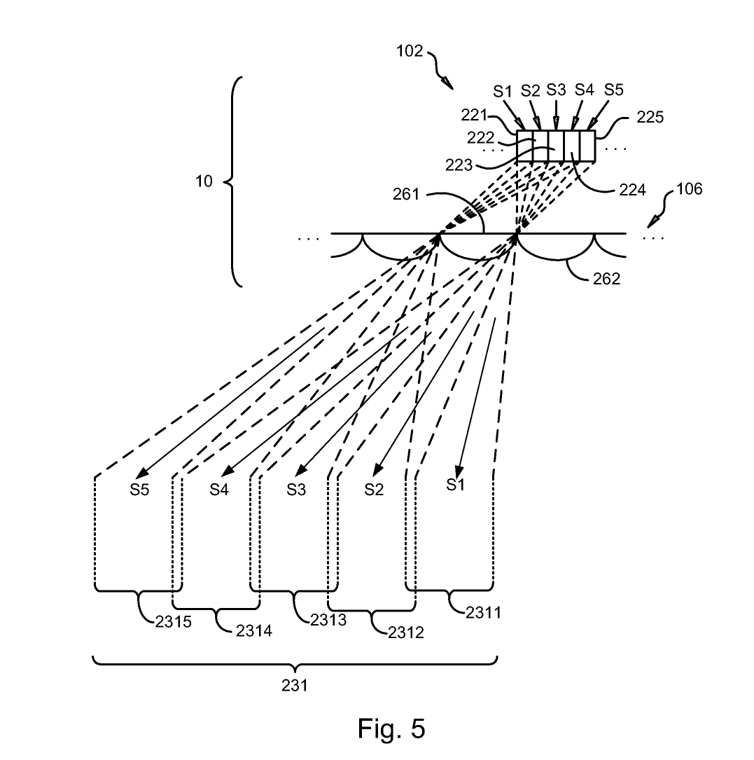

Moreover, projection of the images S1-S5 to the left zone 231 by pixels 221-225 through the lens 261 is shown in FIG. 5. FIG. 5 is a detailed schematic diagram of the pixels 221-225 in FIG. 2 projecting the images to the left zone 231 through the lens 261. The projection by the pixels 221-225 to the left zone 231 through the lens 261 is similar to the projection by the pixels 221-225 to the central zone 232 through the lens 262, thus no repetitious details for those parts is given herein. In addition, projection of the pixels 221-225 to the right zone 233 through the lens 263 is also similar to the projection of the pixels 221-225 to the central zone 232 through the lens 262, thus no repetitious details for those parts is given herein.

In order to make the viewer see the continuous 3-dimensional images with parallaxes while the viewer 90 moves from one zone to another zone (e.g., while the viewer 90 moves from the left side in the central zone 232 to the right side in the left zone 231), the display 10 switches images of the pixels such that the viewer can see the 3-dimensional images with parallaxes (which are continuous to the 3-dimensional image with parallax seen in the original zone) after the viewer 90 moves into another zone.

An example is made to FIG. 6A-FIG. 6E, FIG. 6A-FIG. 6E are schematic diagrams of images from different vision angles according to an embodiment of the present disclosure. Compared to the variation of the relative relations of the image objects A and B in the images Img1-Img5 in FIG. 4A-FIG. 4E, the relative relations of the image objects A and B in the images ImgL1-ImgL5 follows the variation of the images Img1-Img5, which makes the vision angles corresponding to the images ImgL1-ImgL5 follows the vision angles corresponding to images Img1-Img5, in which the images SL1-SL5 correspond to images ImgL1-ImgL5 having different vision angles.

An example is made to FIG. 7, FIG. 7 is a detailed schematic diagram of pixels 221-225 projecting images to the left zone 231 through the lens 262 according to another embodiment of the present disclosure. Compared to FIG. 5, the pixel 221 switches the image S1 shown in FIG. 4A to the image SL1 shown in FIG. 6A such that the pixel 221 projects the image SL1 to the viewable zone 2311 through the lens 261. Therefore, the right eye and the left eye of the viewer 90 capture the image S4 and the image S5 respectively in the original position so as to see the 3-dimensional image. After the viewer 90 moves to a position 94, the right eyes of the viewer 90 captures the image S5, and the left eye captures the image SL1 so as to see another 3-dimensional image. The parallax of another 3-dimensional image follows the parallax of the 3-dimensional image seen in the original position.

While the viewer 90 continues to move to the left, pixels 222-225 respectively switch to the images SL2-SL5 shown in FIGS. 6B-6E in order such that the viewer 90 can see the 3-dimensional image with continuously varied parallax. Therefore, the viewer 90 can see the 3-dimensional images with continuous motion parallax not only while the viewer is located in the central zone 232, the left zone 231 or the right zone 233 shown in FIG. 2, but also while the viewer 90 moves across the zones, e.g., moving from the central zone 232 to the left zone 231. The circumstance that the viewer 90 moves from the central zone 232 to the right zone 233 is similar to the embodiment shown in FIG. 7, thus no repetitious details for those parts is given herein.

From those mentioned above, each pixel respectively defines the three viewable zones through three lenses, and the unobserved zone is formed between the neighboring zones. It should be noted that the viewable zone 2323 is a main-lobe (or so called a 0th order side-lobe) which is defined by the pixel 223 through the lens 262, and the viewable zones 2313 and 2333 are the left 1st order side-lobe and the right 1st order side-lobe defined by the pixel 223 through the lenses 261 and 263, respectively. However, the pixel 223 can also define the left 2nd order side-lobe left 3rd order side-lobe . . . and left nth order side-lobe through multiple lenses on the left of the lens 261, and define the right 2nd order side-lobe, right 3rd order side-lobe . . . and right nth order side-lobe through multiple lenses on the right of the lens 263, in which the n is a positive integer.

The unobserved zone TL23 between the 0th order side-lobe and the left 1st order side-lobe is a left 1st order transition zone, and the unobserved zone TR23 between the 0th order side-lobe and the right 1st order side-lobe is a right 1st order transition zone. Similarly, the unobserved zone between the left (n−1)th order side-lobe and the left nth order side-lobe is a left nth order transition zone, and the unobserved zone between the right (n−1)th order side-lobe and the right nth order side-lobe is a right nth order transition zone.

Regarding to the image switching operation of the pixel, after the detecting device detects the position of the viewer and generates the position data (e.g., the detecting device 104 shown in FIG. 1 detects the position of the viewer 90 so as to generate the position data Dp according to the position of the viewer 90), the pixel corresponding to an unobserved zone switches from an image to another image according to the position data while the viewer is in the unobserved zone.

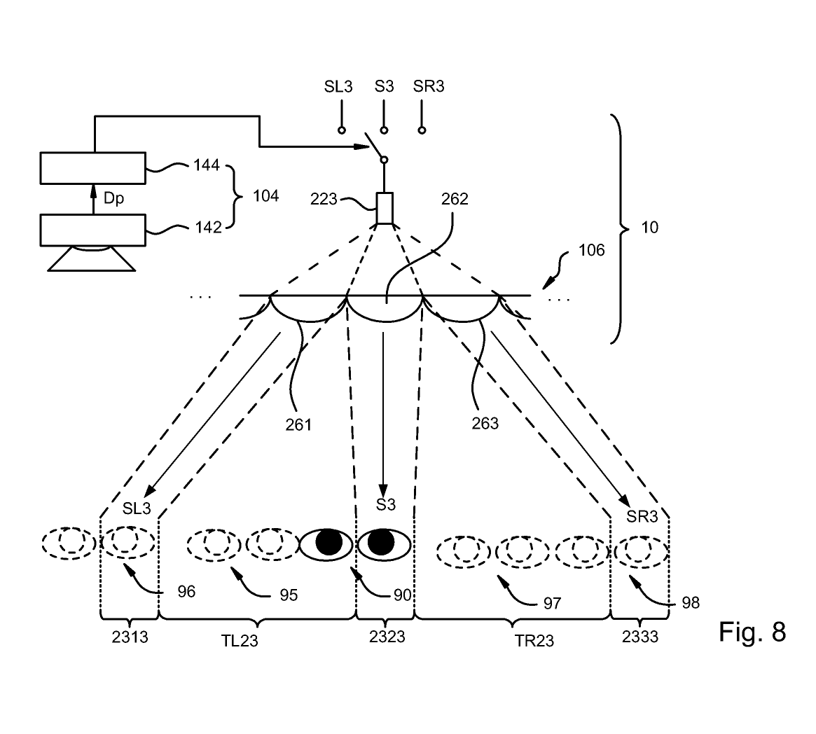

The following illustrates more details based on example provided in FIG. 8. FIG. 8 is a schematic diagram of a single pixel 223 shown in FIG. 2, FIG. 3 and FIG. 5 projecting images according to an embodiment of the present disclosure. The pixel 223 projects images through the lenses 261, 262 and 263 so as to define the viewable zones 2313, 2323 and 2333 corresponding to the pixel 223. The unobserved zone is formed between the consecutive two of the viewable zones 2313, 2323 and 2333 such that the pixel 223 projects that images through the lenses 261, 262 and 263 so as to respectively define the viewable zones 2313, 2323 and 2333 and the unobserved zones TL23 and TR23 corresponding to the pixel 223. The eyes of the viewer 90 can see the image (e.g., the image S3) projected by the pixel 223 in the viewable zones 2313, 2323 and 2333, and the eyes of the viewer 90 cannot see the image projected by the pixel 223 in the unobserved zones TL23 and TR23.

As shown in FIG. 8, the right eye of the viewer 90 sees image S3, and the left eye of viewer 90 sees the image projected by another pixel, e.g., the image S4 shown in FIG. 4D projected by the pixel 224 shown in FIG. 7, such that the viewer 90 sees the 3-dimensional image corresponding to the viewable zone 2323, i.e., the 3-dimensional image corresponding to the vision angle of the viewable zone 2323. Then, the viewer 90 moves to the left such that right eye of the viewer 90 moves from the viewable zone 2323 to the unobserved zone TL23, e.g. the position 95 shown in FIG. 8. In the meanwhile, the detecting device 104 detects the position 95 of the viewer 90 so as to generate the position data Dp. Then the pixel 223 switches from the image S3 to another image, e.g., switching to the image SL3 shown in FIG. 6C according to the position data Dp.

In other words, in some embodiments, the images corresponding to the pixel 223 include the image SL3 and S3. The image S3 corresponds to the 3-dimensional image corresponding to the viewable zone 2323 in which the viewer 90 is located. The image SL3 corresponds to the 3-dimensional image of the viewable zone 2313 where the viewer 90 moves. The parallaxes of the images mentioned above are different. While the position data Dp provided by the detecting device 104 corresponds to the position 96 where the viewer 90 moves, the pixel 223 on the display 10 switches from displaying the image S3 to displaying the image SL3 according to the position data Dp provided by the detecting device 104.

Therefore, while the viewer 90 continues to move to the left to the position 96, the left eye of the viewer is located in the viewable zone 2313 so as to see the image SL3, and the right eye sees an image projected by another pixel, e.g., the image SL2 shown in FIG. 6b projected by the pixel 222 shown in FIG. 7, such that the viewer 90 sees the 3-dimensional image corresponding to the viewable zone 2313, i.e., the 3-dimensional images SL3 and S3 corresponding to vision angle of the viewable zone 2313. In addition, the image switching operation corresponding to the viewer 90 moving in a direction to the viewable zone 2333 until the position 97 is similar to the embodiment mentioned above, thus no repetitious details for those parts is given herein.

Next, detection of the detecting device is illustrated. The detecting device 104 includes the image capturing device 142 and the computing device 144. The image capturing device 142 is configured to get the position data Dp of the viewer 90 in the front of the display 10, in which the position data Dp can get the coordinate information of eyes of the viewer 90 relative to the display 10 according to the computation of real-time image data of the viewer 90. The computation mentioned above can be implemented by the computing device 144. In more details, the detecting device 104 repeatedly captures the image of the viewer located in the front of the display 10. The computing device 144 computes the coordinate information of the eyes of viewer 90 relative to the image capturing device 142, and the computing device 144 transforms the coordinate information to the coordinate information of the eyes of the viewer 90 relative to the display 10 so as to provide the position data Dp, which makes a coordinate system corresponding to the eyes of the viewer 90 be consistent with the pixel coordinate system.

In addition, switching operation of multiple images corresponding to a single pixel on the display (e.g., the three images SL3, S3 and SR3 corresponding to the pixel 223) can be controlled by the computing device 144 shown in FIG. 8, but it is not restricted herein. The switching operation of the image can be controlled by other processing devices, e.g., the central processing unit, in which the computing device 144 can be implemented by a personal computer or a processing chip integrated in the display.

Moreover, from the embodiments mentioned above, each pixel projects images through the three lenses so as to define three viewable zones. In other words, as shown in FIG. 8, the viewable zone 2323 is a main lobe or so called a 0th order side-lobe which is defined by the pixel 223 through the lens 262, and the viewable zones 2313 and 2333 are the left 1st order side-lobe and the right 1st order side-lobe defined by the pixel 223 through the lens 261 and 263. However, the pixel 223 can also define the left 2nd order side-lobe, left 3rd order side-lobe . . . and left nth order side-lobe through multiple lenses on the left hand side of the lens 261, and define the right 2nd order side-lobe, right 3rd order side-lobe . . . and right nth order side-lobe through multiple lenses on the right hand side of the lens 263, in which the n is a positive integer. The unobserved zone TL23 between the 0th order side-lobe and the left 1st order side-lobe is a left 1st order transition zone, and the unobserved zone TR23 between the 0th order side-lobe and the right 1st order side-lobe is a right 1st order transition zone. Similarly, the unobserved zone between the left (n−1)th order side-lobe and the left nth order side-lobe is a left nth order transition zone, and the unobserved zone between the right (n−1)th order side-lobe and the right nth order side-lobe is a right nth order transition zone. Therefore, switching operation of the signals shown in the present disclosure can be applied to the at least three viewable zones and the at least two unobserved zones, in which the switching operation of the signals is similar to the embodiment shown in FIG. 8, thus no repetitious details for those parts is given herein.

From those mentioned above, the viewer can not only see multiple 3-dimensional images from different vision angles in the left zone, the central zone and the right zone but also sees the three dimensional images with continuous motion parallaxes while the viewer crosses the zones through the display of the present disclosure, which makes the viewer get a larger viewable range with continuous motional parallaxes. Moreover, the switching operation of multiple pixels corresponding to a single pixel on the display is finished while the viewer locates in the unobserved zone such that the image switching operation shown in the present disclosure does not affect the view quality of the viewer, and the viewer can see the correct images conforming with the right angle of departure while the viewer is in the viewable zone.

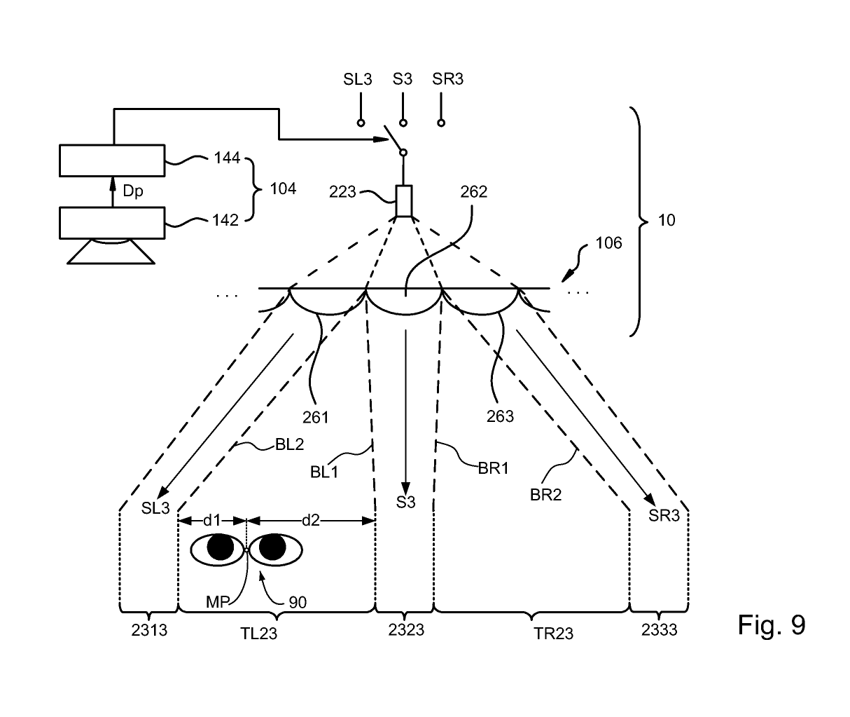

In another embodiment, while the position data detected by the detecting device corresponds to the viewer located in the unobserved zone, the pixel is further configured to switch signal so as to display one of the images mentioned above according to the position data, in which the one of the image is the closest to the viewer. An example is made to FIG. 9. FIG. 9 is a schematic diagram of relative positions of the viewer and the pixel in FIG. 8 according to an embodiment of the present disclosure. The detecting device 104 detects the position of the viewer, such as the position of a midpoint MP of the eyes of the viewer, and provides the position data Dp. The midpoint MP is located in the unobserved zone. A distance between the midpoint MP and the edge BL2 of the viewable zone 2313 is distance d1, and a distance between the midpoint MP and the edge BL1 of the viewable zone 2313 is distance d2. Since the distance d1 is smaller than the distance d2, the computing device 144 determines that the viewer 90 is closest to the viewable zone 2313, and the pixel switches the signal to image SL3 through the computing device 144, in which the image SL3 corresponds to the viewable zone 2313.

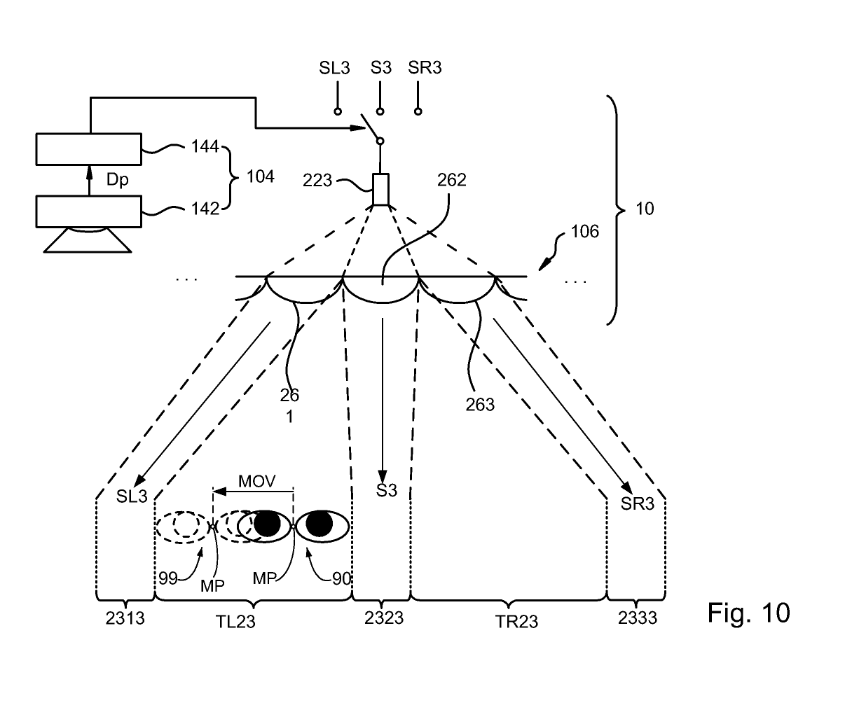

In the next embodiment, while the position data shows that the viewer locates in the unobserved zone and while the viewer moves in one direction provided by the detection of the detecting device, the pixel is configured to switch signal so as to display one of the images, in which the one of the images corresponds to the viewable zone to which the mentioned direction directs. An example is made to FIG. 10, and FIG. 10 is a schematic diagram of relative positions of the viewer and the pixel in FIG. 8 according to another embodiment of the present disclosure. Compare to FIG. 9, the viewer shown in FIG. 10 moves in a direction MOV to the position 99, in which the direction is from the viewable zone 2323 to the viewable zone 2313. After the detecting device 104 detects the position of the viewer and provides the position data Dp, the computing device 144 determines that the viewer 90 can move to the viewable zone 2313. Therefore, the signal of pixel 223 is switched to image SL3 through the computing device 144, in which the image SL3 corresponds to the viewable region 2313.

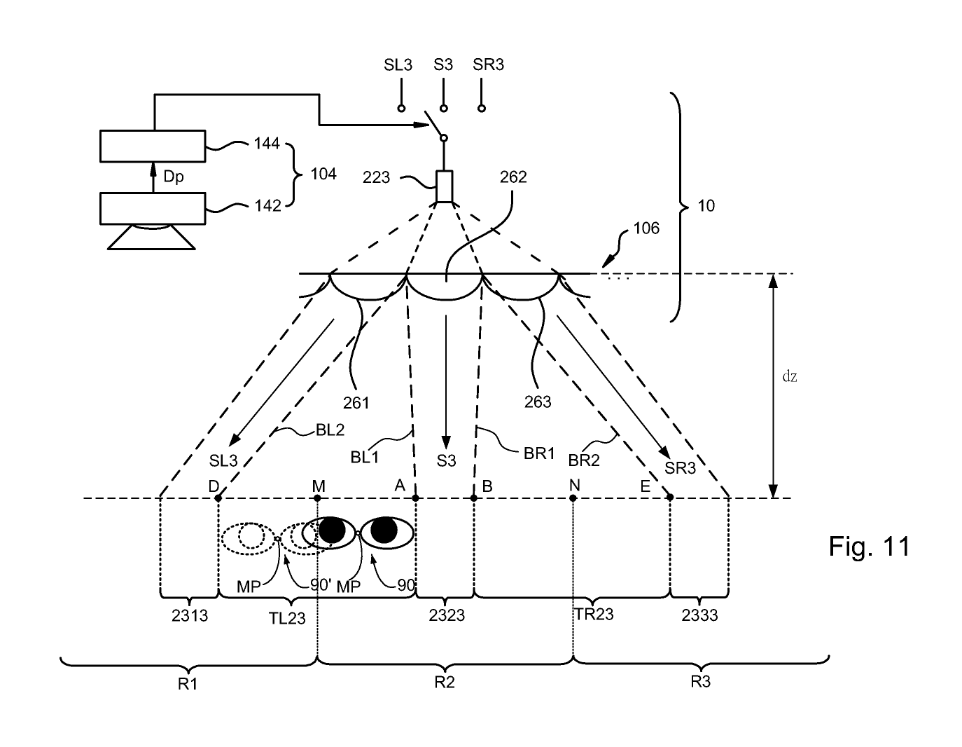

In yet an embodiment, the transition position is given between the viewable zones, and the detecting device detects the viewer relative to the position of the mentioned transition position. While the viewer is located in the unobserved zone, the pixel switches signal base on the mentioned position data. An example is made to the FIG. 11 for a more specific explanation. FIG. 11 is a schematic diagram of relative positions of the viewer and the pixel in FIG. 8 according to a further embodiment of the present disclosure. A transition position M is given between the viewable zone 2313 and the viewable zone 2323, and a transition position N is given between the viewable zone 2313 and the viewable zone 2323. A zone R2 is formed between the position M and position N, a zone R1 is formed on the left of the transition position M and a zone R3 is formed on the right of the transition position M. As the position data Dp corresponds to the position of the viewer 90. e.g., the midpoint MP between the eyes of the viewer 90 in the zone R2 (between the transition point M and N), the pixel 223 projects the image S3 corresponding to the viewable zone 2323. Next, while the position data Dp corresponding to the position of the viewer 90 is in the zone R1, i.e., the zone on the left of the transition M, the pixel 223 projects the image SL3 corresponding to the viewable zone 2313. Moreover, while the position data Dp corresponding to the position of the viewer 90 is in the zone R3, i.e., the zone on the right of the transition position N, the pixel projects the image SR3 corresponding to the viewable zone 2333.

While the viewer 90 is located in the zone R2 between the transition position M and N and located in the unobserved zone TL23 a or TR23, the pixel 223 switches the signal to display the image S3 corresponding to the viewable zone 2323 by the computing device 144 after the detecting device 104 detects the position of the viewer and generates the position data Dp. Next, while the viewer 90 is located in the zone R1 on the left of position M and located in the unobserved zone TL23, the pixel 223 switches the signal to display the image SL3 corresponding to the viewable zone 2313 by the computing device 144 after the detecting device 104 detects the position of the viewer 90 and generates the position data Dp. Moreover, while the viewer 90 is located in the zone R3 which is on the right of position N and located in the unobserved zone TR23, the pixel 223 switches the signal to display the image SR3 corresponding to the viewable zone 2333 by the computing device 144 after the detecting device 104 detects the position of the viewer and generates the position data Dp.

In one embodiment, the position data Dp corresponds to the viewer 90 passing through the transition point M or N, the pixel 223 switches signal according tot the position data Dp. An example is made to FIG. 11, while the viewer 90 moves to the viewable zone 2313 through the transition M, and while the viewer 90 is still in the unobserved zone TL23, the detecting device 104 detects the position of the viewer 90 and provides the position information Dp, the pixel 223 switches signal according to the position data Dp such that the image S3 is switched to image SL3. In contrast, while viewer 90 moves to the viewable zone 2323 from the position 90′ and pass through the transition position M, and while the viewer is still in the unobserved zone TL23, the detecting device 104 detects the position of the viewer and provides the position data Dp, and the pixel 223 switches signal according to the position data Dp such that the image SL3 is switched to image S3. The switching operation corresponding to the viewer 90 passing though the transition position N is similar to the embodiments mentioned above, thus no repetitious details for those parts is given herein.

In the embodiment shown in FIG. 11, the transition position M and the transition position N correspond to the midpoint of the unobserved zone TL23 and the unobserved zone TR23. In more details, a distance between the viewer 90 and the display 10 is a distance dz, and an interval AD is formed in the distance dz relative to the display 10 in the unobserved zone RL23. The transition point M is the midpoint of the interval AD. In the same rationale, as shown in FIG. 11, the transition N is the midpoint of an interval BE.

From the embodiments mentioned above, with regard to the parallel movement of the viewer relative to display, the transition position defined by the midpoint of the unobserved zone provides more reaction time for switching signal and gives more failure tolerance to the computation process of the switching operation.

It is noted that transition positions can also be defined in the left 1st order, the left 2nd order . . . the left nth order, the left (n+1)th order transition zone (or called the unobserved zone) and the right 1st order, the right 2nd order . . . the right nth order, the right (n+1)th order transition zone such that while the viewer 90 is located between transition positions in the left nth order and the left (n+1)th order transition zone, the pixel 223 switches to signal which is the image corresponding to the left nth order side-band according to the position data Dp. While the viewer 90 is located between transition positions in the right nth order and the right (n+1)th order transition zone, the pixel 223 switches signal to the image corresponding to the right nth order side-lobe according to the position data Dp.

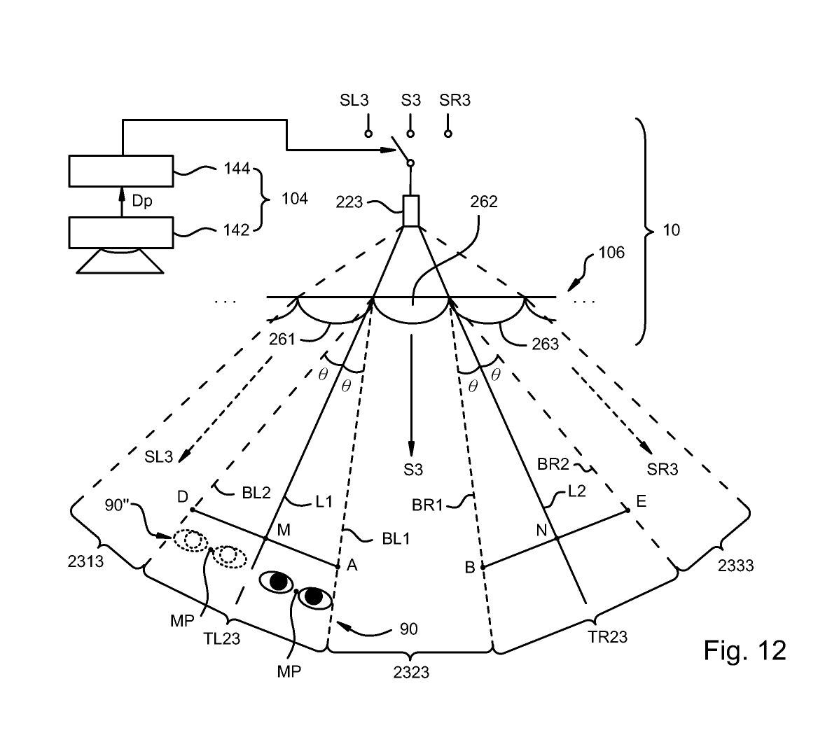

In another embodiment, transition position can be defined by angle bisector points between the neighboring edges of the neighboring viewable zone. An example is made to FIG. 12. FIG. 12 is a schematic diagram of relative positions of a viewer and a pixel according to another embodiment of the present disclosure. Compared to FIG. 11, the transition position M and the transition position N are defined by the interconnection of the angle bisectors L1, L2 in the unobserved zones TL23, TR23 and the intervals AD and BE. In the embodiment shown in FIG. 12, signal switching operation according to the position data Dp of viewer 90 (relative to the transition position M and transition position N) is similar to those shown in the embodiment shown in FIG. 11, thus no repetitious details for those parts is given herein.

From the embodiment mentioned above, regarding to the arc-curve movement of the viewer opposing to and surrounding the display, the transition position, which is defined by the points of the angle bisectors of the unobserved zone, provides more reacting time for switching signals and gives better failure tolerance of the computation process of the switching operation.

One aspect of the present disclosure is to provide a method of displaying multiple 3-dimensional images with different parallaxes. Reference is made to FIG. 1 and FIG. 8 for further illustration. The method includes the following steps: displaying multiple images (e.g., embodiments shown in FIG. 3 and FIG. 7) corresponding to the 3-dimensional images with difference parallaxes (e.g., embodiments shown in FIGS. 4A-4E and FIGS. 6A-6E) by pixels 1021-102n; next, cooperating each pixel with the optical unit to display the corresponding images and project the corresponding images to multiple viewable zones, for example, the optical unit includes lenses 261, 262 and 263, pixels 1021-102n include pixel 223, and the pixel 223 cooperates with lenses 261, 262 and 263 to project the images SL3, S3 and SR3 to the corresponding zones 2313, 2323 and 2333; and forming an unobserved zone between consecutive two of the viewable zones, for example, the unobserved zone TL23 is formed between the viewable zone 2313 and the viewable zone 2323, and the unobserved zone TR23 is formed between the viewable zone 2333 and the viewable zone 2323; and selectively switching signals by each pixel 1021-102n according to the position data Dp so as to display the corresponding images, in which the step of selectively switching signals includes: while the position data Dp corresponds to the viewer 90 located in the unobserved zone TL23 or TR23, switching from one of the images SL3, S3 and SR3 to another one of the images SL3, S3 and SR3 according to the position data Dp by the pixel 223 of the pixels 1021-102n. The 3-dimensional images with different parallaxes are illustrated in the embodiments shown in FIG. 3 and FIG. 7. The images are illustrated in the embodiments shown in FIGS. 4A-4E and FIGS. 6A-6E, thus no repetitious details for those parts is given herein.

Reference are made to FIG. 1 and FIG. 8, in one embodiment, the images include image S3 and image SL3. The image S3 is the 3-dimensional image seen from the viewer 90 who is in the viewable zone 2323. The image SL3 is the 3-dimensional image seen from the viewer 90 who is at the position 96 in the viewable zone 2313. The two 3-dimensional images mention have different parallaxes. Then, step of selectively switching signals by the pixels 1021-102n according to the position data Dp so as to display the corresponding images includes the following steps, while the position data Dp corresponds to the viewer 90 moving from an original position to another position, switching from a displayed image to another displayed image by the pixels 1021-102n according to the position data Dp.

For example, the original position of the viewer 90 is in the viewable zone 2323, another position 96 of the viewer 90 is in the viewable zone 2313, and the viewable zone 2323 and viewable zone 2313 corresponds to the pixel 223. Therefore, pixel 223 switches from the displayed image S3 to the displayed image SL3 corresponding to the position data Dp, in which the position data corresponds to the viewable zone 2313 and the viewable zone 2323. The switching operation is executed while the viewer 90 is in the unobserved zone TL23.

Reference is made to FIG. 1 and FIG. 9. In another embodiment, the step of selectively switching signals by each pixel 1021-102n according to the position data Dp so as to display the corresponding images includes the following steps: while the position data Dp is generated by detection of the viewer 90 located in the unobserved zone, switching signal by pixels 1021-102n according to the position Dp so as to display the image corresponding to the viewable zone which is the closest to the viewer 90. For example, while the viewer is located in the unobserved zone TL23, and after the detecting device 104 detects the position of the viewer 90 and provides the position data Dp, the pixel 223 corresponding to the unobserved zone TL23 switches signals so as to display the image corresponding to the viewable zone which is the closest to the viewer 90. Since the distance between the midpoint of the eyes of the viewer 90 and the viewable zone 2313 is smaller than the distance between the midpoint of the eyes of the viewer 90 and the viewable zone 2323, the pixel 223 switch to images SL3, in which the image SL3 corresponds to the viewable zone 2313.

Reference is made to FIG. 1 and FIG. 10, in another embodiment, the step selectively switching signals by each pixel 1021-102n according to the position data Dp so as to display the corresponding images includes the following steps: while the position data Dp is detected and generated, in which the position data Dp indicates that the viewer 90 is in the unobserved zone and moves in one direction, the pixels 1021-102n switch signals according to the mentioned direction so as to display the image corresponding to which the mentioned direction directs. An example is made to FIG. 10. Compared to FIG. 9, the viewer 90 shown in FIG. 10 moves to the position 99 in direction MOV, in which the direction MOV is from the viewable zone 2323 to the viewable zone 2313. After the detecting device 104 detects the position of the viewer 90 and provides the position data Dp, the computing device 144 identify that the viewer 90 moves to the viewable zone 2313. Therefore, the pixel 223 switches signals to image SL3 through computing device 144, in which the image SL3 corresponds to the viewable zone 2313.

From those mentioned above, the viewer moving across the zones can see the 3-dimensional images with continuous motion parallaxes by the method of displaying 3-dimensional images shown in the present disclosure, and a larger viewable range of the viewer with continuous motion parallaxes is obtained by the method of displaying 3-dimensional images shown in the present disclosure. Moreover, switching operation of multiple images corresponding to a single pixel is executed while the viewer is located in the corresponding unobserved zone, which makes the switching operation of the images shown in the present disclosure not affect the viewing quality of the viewer, and the viewer can see the correct images conforming with the right angle of departure while the viewer is in the viewable zone.

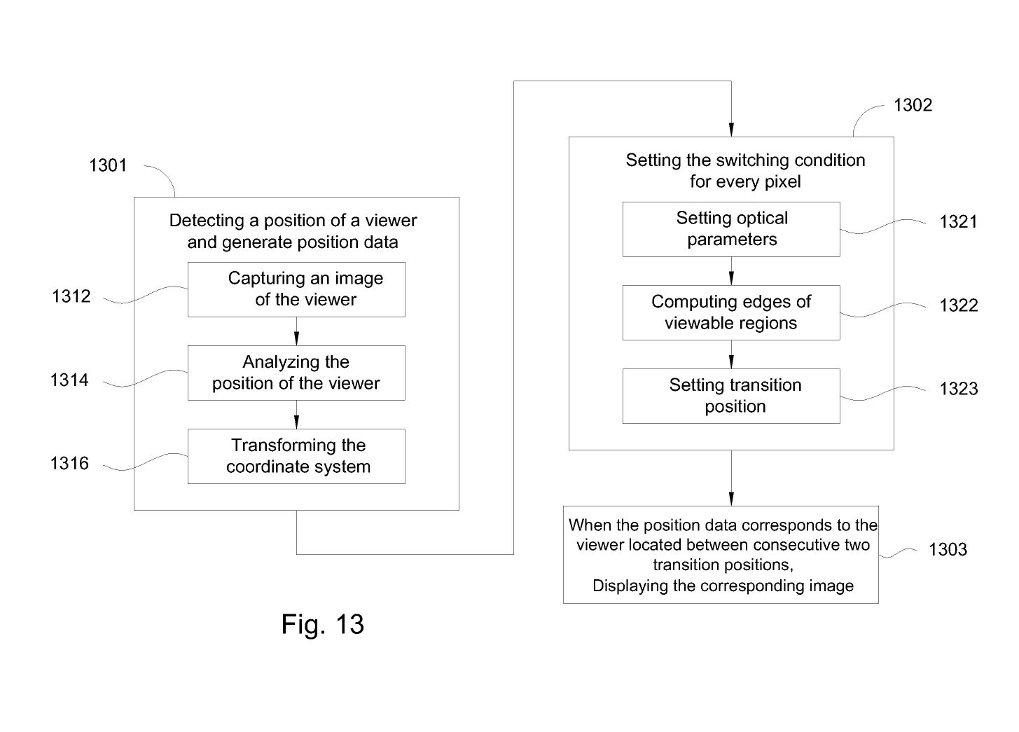

Reference is made to FIG. 11 and FIG. 13 for a more detailed illustration of the operation flow, in which FIG. 13 is a flow diagram of operation according to an embodiment of the present disclosure. As shown in FIG. 13, detecting the position of the viewer 90 so as to generate position data Dp according to the position of the viewer 90 is step 1301. Setting the switching condition to each pixel is step 1302. While the position data corresponds to the viewer 90 located in between the two transition positions, and while the viewer is located in the unobserved zone, switching signals by the pixel 223 so as to display the corresponding image is step S1303. It should be noted that the operation order of the step 1301 and step 1302 can be switched, or the step 1301 and step 1302 can be operated in the same time.

The step S1301 includes the following steps: obtaining the image of the viewer 90 in the front of the display 10 by the image capturing device 142 (step 1312); next, computing and analyzing the real-time image of the viewer 90 by the computing device 144 so as to obtain the coordinate information of the eyes of the viewer 90 relative to the image capturing device 142 (step 1314); then, transforming the mentioned coordinate information to a coordinate information of the eyes of the viewer in relative to the display 10 so as to obtain the position information Dp (pixel coordinate system) (1316), which makes the coordinate system corresponding to the eyes of the viewer 90 be consistent with the pixel coordinate system.

The step 1302 includes the following steps: first, setting the optical parameters; next, computing the edges of the viewable zones of each pixel according to the optical parameters (step 1322); then, setting the transition positions according to the edges of computed viewable zones (step 1323); next, while the position data Dp corresponds to the viewer 90 located between the consecutive two of the transition positions, and while located in the unobserved zone, the pixel switches signal so as to display the corresponding image (step 1303).

The pixel 223 is taken as an example for step 1302. First, setting the optical parameters (1321), in which the optical parameters can be the relative positions between the pixel 223 and the optical unit 106, or the curvature radiuses and focal lengths of the lenses 261, 262 and 263 on the optical unit 106; next computing the edges BL1, BL2, BR1 and BR2 of the viewable zones 2313, 2323 and 2333 according to the optical parameters (1322); then, setting the transition position M according to the edge BL1 of the viewable zone and the edge BL2 of the viewable zone 2313, and setting the transition position N according tot the edge BR1 of the viewable zone 2323 and the edge BR2 of the viewable zone 2333.

Next (Step 1303), while the position data Dp corresponds to the viewer 90 located between the consecutive two transition positions M and N, the computing device 144 determines that the pixel 223 displays the image S3 corresponding to the viewable zone 2323 between the transition positions M and N. While the position data Dp corresponds to the viewer located on the left of the transition position M or on the right of the transition position N, the computing device 144 determines that the pixel 223 displays the image SL3 corresponding to the viewable zone 2313 on the left of the transition position M or the image SR3 corresponding to the viewable zone 2333 on the right of the transition N. Step 1303 illustrates that the computing device 144 determines that the pixel 223 displays the corresponding image according to the position data Dp. And the pixel 223 executes the switching operation of the signals while the position data Dp corresponds to the viewer 90 located in the unobserved zone.

In addition, step 1302 shown in FIG. 13 can also be applied to the circumstance that the single pixel having at least three viewable zones. In other words, the transition positions can also be defined in the left 1st order, the left 2nd order . . . the left nth order, the left (n+1)th order transition zones (or so called the unobserved zones) and the right 1st order, the right 2nd order . . . the right nth order, the right (n+1)th order transition zones such that the pixel 223 switches to the image corresponding to the left nth order side-lobe while the viewer 90 is located between transition positions in the left nth order and the left n+1th order transition zone. While the viewer 90 is located between transition positions in the right nth order and the right n+1th order transition zones, the pixel 223 switches to image corresponding to the right nth order side-lobe.

As shown in FIG. 11, the transition positions M and N are defined by the midpoint of the interval AD and interval BE in the unobserved zone. As shown in FIG. 12, transition positions M and N can be defined by the angle bisector points on the intersection of the angle bisectors and the intervals AD and BE in the unobserved zone, in which the detailed setup of the transition positions M and transition position N are mentioned above. Thus, no repetitious details for those parts are given herein.

In addition, as shown in FIG. 11, in another embodiment, selectively switching signals by the pixel according to the position data so as to display the corresponding image includes the following steps: for each pixel, such as pixel 223, while the position data Dp corresponds to the viewer 90 passing through the transition position M or the transition position N, and while the viewer locates in the unobserved zones TL23 or TR23, switching the signals by the pixel according to the position data Dp so as to switch from one image to another image, for example, while the position information Dp corresponds to the viewer 90 moving from the right of the transition position M to the left of the transition position M, switching the signals from the image S3 to another image SL3 according to the position data Dp.

From the embodiment above, with regard to the arc-curve movement of the viewer opposing to and surrounding the display, the transition position, which is defined by the angle bisector points of the unobserved zone, provides more reacting time for switching signals and gives better failure tolerance of the computation process of the switching operation.

The advantages of applying the present disclosure is that the viewer can not only see multiple 3-dimensional images from different vision angles while he/she is located in the left zone, the central zone and the right zone but also see the 3-dimensional images with continuous motion parallaxes through the display of the present disclosure while the he/she moves across the zones, which makes the viewer obtain a larger viewable range with continuous motion parallax. Moreover, switching operation of multiple pixels corresponding to a single pixel on the display is finished while the viewer is located in the unobserved zone, which makes the image switching operation shown in the present disclosure not affect the viewing quality of the viewer. And the viewer can see the correct images conforming to the right angles of departure while the viewer is in the viewable zone.

Furthermore, application of switching operation such as the configuration of the transition positions shown in the present disclosure, e.g. the transition positions defined by the midpoint or the angle bisector points of the unobserved zones, provides more reaction time switching signal and gives more failure tolerance to the computation process of the switching operation.

Although the present disclosure has been described in considerable details with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A display configured to provide images to a viewer, the display comprising:
a plurality of pixels, each of the pixels configured to display a first image;
a detecting device configured to detect a position of the viewer to generate position data according to the position of the viewer; and
an optical unit, each of the pixels configured to cooperate with the optical unit to project the first image to a plurality of viewable zones, wherein an unobserved zone is formed between consecutive two of the viewable zones;
wherein each of the pixels is configured to switch from displaying a first image to displaying a second image while the position data corresponds to the viewer located in the unobserved zone.

2. The display as claimed in claim 1, wherein each first image is configured to cooperate with the optical unit to form a first 3-dimensional image in a first viewable zone of the viewable zones, and each second image is configured to cooperate with the optical unit to form a second 3-dimensional image in a second viewable zone of the viewable zones, and parallaxes of the first 3-dimensional image and the second 3-dimensional image are different.

3. The display as claimed in claim 2, wherein while the position data corresponds to the viewer located in the unobserved zone, each of the pixels is further configured to display the first image or the second image based on which of the first viewable zone corresponding to the pixel and the second viewable zone corresponding to the pixel is closer to the viewer according to the position data.

4. The display as claimed in claim 3, wherein a first transition position is defined between the first viewable zone and the second viewable zone, and each of the pixels displays the first image or the second image based on which side of the first transition position the viewer is located on.

5. The display as claimed in claim 4, wherein the first transition position is set at a midpoint of the unobserved zone between the first viewable zone and the second viewable zone, or the first transition position is set at a angle bisector point between the neighboring edges of the first viewable zone and the second viewable zone.

6. The display as claimed in claim 2, wherein while the position data corresponds to the viewer located in the unobserved zone and the viewer moves in a direction, each of the pixels is further configured to display the first image or the second image based on the direction pointing to the first viewable zone of the pixel or pointing to the second viewable zone of the pixel.

7. The display as claimed in claim 6, wherein a first transition position is defined between the first viewable zone and the second viewable zone, and each of the pixels displays the first image or the second image based on which side of the first transition position the viewer is located on.

8. The display as claimed in claim 7, wherein the first transition position is set at a midpoint of the unobserved zone between the first viewable zone and the second viewable zone, or the first transition position is set at a angle bisector point between the neighboring edges of the first viewable zone and the second viewable zone.

9. The display as claimed in claim 2, wherein a first transition position is defined between the first viewable zone and the second viewable zone, and each of the pixels displays the first image or the second image based on which side of the first transition position the viewer is located on.

10. The display as claimed in claim 9, wherein the first transition position is set at a midpoint of the unobserved zone between the first viewable zone and the second viewable zone, or the first transition position is set at a angle bisector point between the neighboring edges of the first viewable zone and the second viewable zone.

11. A method for displaying multiple 3-dimension images with different parallaxes, comprising:
displaying a first image by a plurality of pixels, cooperating each of the pixels with an optical unit to project the first image to a plurality of viewable zones, and forming an unobserved zone between consecutive two of the viewable zones;
detecting a position of a viewer to generate position data according to the position of the viewer; and
selectively switching image according to the position data, wherein selectively switching the image displayed by the pixels comprises:
switching the image displayed by one of the pixels from the first image to the second image while the position data corresponds to the viewer located in the unobserved zone of the one of the pixels.

12. The method as claimed in claim 11, wherein the first image is configured to cooperate with the optical unit to form a first 3-dimensional image in a first viewable zone of the viewable zones, and the second image is configured to cooperate with the optical unit to form a second 3-dimensional image in a second viewable zone of the viewable zones, and parallaxes of the first 3-dimensional image and the second 3-dimensional image are different.

13. The method as claimed in claim 12, wherein the step of while the position data corresponds to the viewer located in the unobserved zone of one of the pixels, switching the image displayed by the pixel from the first image to the second image further comprises:
while the position data corresponds to the viewer located in the unobserved zone, determining which of the first viewable zone or the second viewable zone is closer to the viewer according to the position data, and switching the image displayed by the pixel to the first image or the second image.

14. The method as claimed in claim 12, wherein the step of while the position data corresponds to the viewer located in the unobserved zone of one of the pixels, switching the image displayed by the pixel from the first image to the second image further comprises:
while the position data corresponds to the viewer located in the unobserved zone, and while the viewer moves in a direction, switching the pixel to display the first image or the second image based on the direction pointing to the first viewable zone of the pixel or pointing to the second viewable zone of the pixel.

15. A display comprising:
means for displaying a first image by a plurality of pixels, cooperating each of the pixels with an optical unit to project the first image to a plurality of viewable zones, and forming an unobserved zone between consecutive two of the viewable zones;
means for detecting a position of a viewer to generate position data according to the position of the viewer; and
means for selectively switching image according to the position data, wherein means for selectively switching the image displayed by the pixels comprises:
mean for switching the image displayed by one of the pixels from the first image to the second image while the position data corresponds to the viewer located in the unobserved zone of the one of the pixels.
